(19) United States
(12) Patent Application Publication
(10) Pub. No.: US 2015/0366249 A1
(43) Pub. Date: Dec. 24, 2015

(54) Fruit-Containing Snack Foods and Manufacture Thereof

(71) Applicant: FRITO-LAY TRADING COMPANY GMBH, Berne (CH)

(72) Inventors: Michelle Louise LOCK, Suffolk (GB); Ben BARLOW, Leicester (GB); Adrienne BARRETT, Leicester (GB); John Richard BOWS, Leicestershire (GB); Beverley CRAWFORD, Leicester (GB); Joanna Louise PEART, Lincolnshire (GB)

(73) Assignee: FRITO-LAY TRADING COMPANY GMBH, Berne (CH)

(21) Appl. No.: 14/765,124

(22) PCT Filed: Jan. 28, 2014
(86) PCT No.: PCT/EP2014/051639

§ 371 Date: Jul. 31, 2015

(30) Foreign Application Priority Data
Jan. 31, 2013 (GB) 1301682.9

(51) Int. Cl. A23L 1/212

(52) U.S. Cl. CPC A23L 1/2128; A23V 2002/00

(57) ABSTRACT

A method of manufacturing a fruit-containing snack food comprises providing a fruit material comprising whole fruit solids; providing a binder material, the binder material being selected from the group comprising cereal material, starch material, nuts seeds, egg, soy, pulses and dairy material; mixing together the fruit material and the binder material to form a mixture having a weight ratio of whole fruit solids: binder material solids of from 0.6:1 to less than 4:1, the whole fruit solids and binder material solids each being on a dry basis, and a moisture content of from 49 to 75 wt % based on the weight of the mixture; forming the mixture such that it has a thickness of between 1 and 4 millimetres; and cooking the mixture in a vacuum-controlled atmosphere having a pressure of less than 1 bar absolute.

### TECHNICAL FIELD

The present invention relates to fruit-containing snack foods and to methods of manufacture of such snack foods. In particular, the present invention relates to snack foods which combine fruit with optional additional ingredients to form a snack food product which has a characteristic and unique crunchy texture, coupled with a melt-in-the-mouth, dissolvable property. This characteristic texture is a function of the unique microstructure of the snack food product, which is in turn achieved by a particular method of manufacture of the snack food from the fruit, with optional additional ingredients.

### DESCRIPTION OF RELATED ART

There is an increasing recognition of the need to consume healthy foods. In the field of snack foods, there has been a recent focus on producing snack foods which have a significant content of fruit matter and have a high nutritional content.

With respect to the consumer need in the field of snack foods, fresh fruit provides a wide range of nutrients considered to be good to health and wellbeing, but can be inconvenient in its whole form, for example being wet or messy, having a short shelf life, and being time consuming to eat. There are government schemes in a large number of countries that encourage consumers to eat more servings of fruit and vegetables. There are a range of formats in which fruit can be considered for a serving, including but not limited to, fresh, dried, powdered, fried, puree, concentrated puree, juice, concentrated juice, and pomace. This gives manufacturers a range of ingredients and raw materials that can be used within processed foods in order to provide ‘fruit content’ for the consumer. There are two formats of fruit that can be used, namely whole fruit or slices of whole fruit as the finished product or as an ingredient within a composite product.

The available range of ambient stable fruit-based snacks have attributes that limit their appeal, such as added sugar, added flavours, chewy textures, and unappealing visual appearance.

Ambient stable fruit products have a low moisture content and/or water activity. There are many ways in which fruit, whole, sliced, pureed or juiced, is preserved in this way. Those methods include, but are not limited to, dehydration, using a fluid bed dryer, spray drying, air drying, baking, roller drying, freeze drying, vacuum drying, vacuum frying, kettle frying, or vacuum microwave drying, intermediate moisture (using dehydration plus solute addition), ultra high temperature (UHT) treatments (such as steam injection, plate or scraped surface heat exchangers, or microwave or ohmic heating), and low acid and hot fill, or other sterilisation processes.

In ambient shelf stable snack foods, product developers face a constant challenge of how to achieve a desirable texture (such as initial crunch or hardness/resistance to bite) and so-called mouth feel (such as rate of breakdown of product in the mouth, rate of mouth clearance, existence of slimy mouth feel or other negatives, teeth clogging, chewiness, oiliness or dryness or powdery textures).

Specifically whole or sliced dried or dehydrated fruit are disadvantaged by the fact that consumers may find them polarizing in flavour, texture or appearance and therefore they have limited consumer appeal.

Where the ingredients include temperature-sensitive materials such as fruit, the challenge is further complicated, since the use of standard oven drying techniques at high temperature are not suitable due to the risk of charring which can lead to discoloration (over-browning of product), poor flavour and also significant loss of nutrient value.

One method to mitigate the risk of high temperature drying is to dry at a lower temperature for a longer time. There are several reasons why products made in this way do not meet consumer needs. Products that are slowly dried (such as air drying of whole slices or roller drying of puree based products) have a non-crisp chewy texture, with a long breakdown in the mouth. Composite products made in this way (made from fruit purees or juice concentrates, but also other ingredients) are also chewy (typically in the form of bars, flakes or sweets/candy gums). In addition they contain many ‘additives’ including flavourings and in some cases, sugar or sugar based syrups, gelling agents, starches, etc.

Other methods that can give open, light textures are: vacuum frying, vacuum microwave drying, freeze drying. Frying or vacuum frying will result in high levels of fat in the finished product and therefore do not meet the healthy perception required by consumers. Freeze drying is a very expensive process and the resultant products are expensive and have a powdery compacting texture, which is slimy when rehydrated in the mouth, and additionally the flavor is very strong as the freeze drying process concentrates the flavor with minimal process losses. Vacuum microwave drying of whole fruit or slices results in chewy textures (unless sugar infusions are added) because of a significant pre-dry phase to make it economically viable.

Many dried food products which are ambient shelf stable and contain fruit have been developed using such processes.

Until now, for the reasons given above, products that have been developed that contain fruit have been processed using a variety of low temperature drying methods such as freeze drying or roller drying in order to create a dried piece suitable for use as a convenient snack.

These snacks contain many desirable flavour attributes, in large part because they have avoided the charring that may result when using high-temperature drying techniques. However, in the area of ambient dried snack foods containing fruit, and where existing low temperature methods of manufacture are used, such as freeze drying, the texture challenges of delivering crunch and non-slimy mouth feel have not been solved to date.

The typical sensory attributes of these products is not crunchy, but instead soft bite, powdery and slimy. The inventors have studied snack foods for many years and significant research indicates that these textural profiles would typically not be accepted or highly liked by mainstream consumers, where a more crunchy texture with a non-slimy mouth feel, which may be exhibited by a melt-in-the-mouth property, would be more desirable.

### SUMMRY OF THE INVENTION

The present invention aims to provide a fruit-based snack food which has the combination of a crunchy texture and a non-slimy mouth feel, which may be exhibited by a melt-in-the-mouth property.

The present invention also aims to provide a method of manufacturing such a fruit-based snack food.

Accordingly, the present invention provides a method of manufacturing a fruit-containing snack food, the method comprising the steps of: a. providing at least one fruit material comprising whole fruit solids; b. providing at least one binder material, the at least one binder material being selected from the group comprising cereal material, starch material, nuts seeds, egg, soy, pulses and dairy material; c. mixing together the at least one fruit material and the at least one binder material to form a mixture having a weight ratio of whole fruit solids: binder material solids of from 0.6:1 to less than 4:1, the fruit solids and binder material solids each being on a dry basis, and a moisture content of from 49 to 75 wt % based on the weight of the mixture; d. forming the mixture such that it has a thickness of from 1 to 4 mm, optionally from 1 to 3 mm, further optionally from 1 to 2 mm, and e. cooking the mixture in an vacuum-controlled atmosphere having a pressure of less than 1 bar absolute.

The present invention further provides a fruit-containing snack food, the snack food comprising a substantially rigid matrix in the form of a sheet and defining therein a cellular structure of voids, the matrix comprising a substantially homogeneous cooked mixture of at least one fruit material and at least one binder material, the at least one binder material being selected from the group comprising cereal material, starch material, nuts seeds, egg, soy, pulses and dairy material; wherein the matrix has a weight ratio of whole fruit solids: binder material solids of from 0.6:1 to less than 4:1, the whole fruit solids and binder material solids each being on a dry basis.

Preferred features are defined in the dependent claims.

### BRIEF DESCRIPTION OF THE DRAWINGS

Embodiments of the present invention will now be described by way of example only, with reference to the accompanying drawings, in which:

FIG. 1 shows a flow chart illustrating a method of manufacturing a fruit-containing snack food in accordance with a first embodiment of the present invention;

FIG. 2 shows a flow chart illustrating a method of manufacturing a fruit-containing snack food in accordance with a second embodiment of the present invention;

FIG. 3 shows a cross-section, taken by light microscopy, through a fruit-containing snack foods produced in accordance with an Example of the present invention; and

FIGS. 4a, 4b and 4c each show a cross-section, taken by C-Cell imaging, through a respective fruit-containing snack food, the snack food of FIG. 4a being produced in accordance with an Example of the present invention and the snack food of FIGS. 4b and 4c being freeze-dried fruit-containing snack foods not produced in accordance with the present invention; and

FIGS. 5a, 5b and 5c shows box plots respectively comparing the cell alignment values, cell contrast values and number of cell values as determined by C-Cell analysis of products according to Examples of the present invention and Comparative Examples of existing commercial products.

### DETAILED DESCRIPTION OF THE INVENTION

Referring to FIG. 1, the flow chart illustrates one embodiment of a method of manufacturing a fruit-containing snack food.

In a first step 2 at least one fruit material comprising whole fruit solids is provided. For the purposes of this disclosure, and the claims herein, the term “whole fruit solids” is defined as the proportion of solid material which comes from fruit in the form of one or more of a fruit puree, paste or pomace, or a fruit powder or flake produced by spray drying or freeze drying or flaking whole fruit material which still contains cellular wall material from the fresh fruit.

The fruit material is typically in the form of one or more of a fruit puree, fruit juice, fruit pieces, each in a fresh or concentrated form, or fruit powder produced by a spray drying or freeze drying process. In preferred embodiments the at least one fruit material includes cellular wall material, ideally intact fruit cells, from the whole fresh fruit, for example from grated fresh fruit, which provides high fruit flavour and good texture within the matrix.

The fruit material may include any edible fruit or combination of edible fruits. For example, the fruit material may be selected from strawberry, raspberry, blackberry, blackcurrant, blueberry, cranberry, banana, apple, pear, plum, peach, apricot, orange, mandarin, lemon, grapefruit, lime, mango, cherry, pineapple, kiwi, pomegranate and grape or any mixture of two or more of these fruits.

The fruit solids are predominately sugars, with seeds and cell wall material in various proportions according to degree of processing used. Very high fruit content, for example greater than 90 wt % of the ingredient mixture, results in a very light open but glassy texture and very sweet flavour. The snack food product becomes very brittle and is unlikely to be commercially viable due to its fragility during transportation.

Different types of fruit can be selected to give variable fruit flavour impact (e.g. blackcurrant gives much more intense flavour than apple at the same wt % value).

Moisture is at least partly added via fruit addition. Fruit can be in the format (and combination) of fresh puree, juice, pomace, paste and concentrated versions thereof. Fresh, frozen, diced, shredded fruit can also be added.

The fruit content may be provided by single strength or concentrated strength fruit puree, and/or by freshly pressed fruit juice or fruit juice concentrate. In each case it may be necessary to provide the desired moisture content by adjusting the ingredient composition for moisture content or brix.

Fruit can also be added whole, for example as fresh or grated fruit. Such fruit addition would be combined with fruit puree or juice, for example. The addition of whole fruit increases the residual solids in the mouth after dissolution of the majority of the matrix in the mouth, and the snack food has a chewier texture because of the whole fruit cell structure.

In a second step 4, which may be before, after or simultaneous with the first step 2, at least one binder material is provided. The at least one binder material is selected from the group comprising cereal material, starch material, nuts seeds, egg, soy, pulses and dairy material.

Preferably, the cereal material is in the form of at least one of a cereal flour, a cereal powder, cereal flakes, or cereal granules or any mixture of two or more of these cereal materials. In preferred embodiments the cereal flour, powder, flakes and/or granules are selected from one or more of oats, wheat, rice, corn and barley or any mixture thereof. Fine flours give a finer blend of ingredients which aids matrix formation and in turn contributes to expansion and formation of the light, crispy texture and open aerated structure.

For example, oat flour may be added to the ingredient mixture at an amount of 0 to 35 wt %; a higher amount would tend to provide a more chip-like crumbly breakdown or an excessively dry texture masking any fruit flavour.

Preferably, the starch material is selected from one or more of oat starch, wheat starch, rice starch, corn starch, tapioca starch and potato starch or any mixture thereof, any such starch material optionally being a modified starch, or optionally a pre-gelatinised starch.

The dairy material adds a pleasant sour/acidic note to the taste of the snack food and can enhance the creaminess of the taste, as well as enhance the dissolution and mouthfeel characteristics. Optionally, the dairy material is in the form of at least one of fresh yoghurt, kefir, milk, cream, whey, a one or more milk derivatives or dry powder or any mixture thereof. Preferably, the dairy material is in the form of at least one of fresh yoghurt or dry yoghurt powder or any mixture thereof.

Moisture can also be added to the ingredient mixture by the use of fresh yogurt, which may be whole, low fat, set or natural yoghurt, as a binder ingredient. The added yoghurt provides a light melting characteristic and pleasant sour note, and typically comprises up to 35 wt % of the ingredient mixture, dependent of the type of yogurt. Above this level, the snack food product becomes very strong in yogurt flavour, and the fresh fruit flavour is reduced.

The binder material may additionally comprise at least one sugar material. In some embodiments the sugar material is selected from sucrose, fructose and refined sugar syrup or any mixture thereof. Typically, fruit sugar is used. The fructose may be derived from fruit juice concentrate. The sugar material may be added alone or combination with other binder/structuring ingredients, such as any sources of starch or proteins.

Various other optional ingredients may be present, such as flavorants or additives to provide sensory properties, such as inclusions, or formulated or natural flavourings, for example to enhance fruit flavour. For example, chocolate, seeds, fruit pieces, etc. may be added, these being mere examples of a wide range of optional additional ingredients which can be added without changing the essential matrix structure or texture characteristics or manufacturing process as discussed herein, as would be apparent to those skilled in the art.

In a third step 6 the at least one fruit material and the at least one binder material are mixed together to form a mixture having a weight ratio of whole fruit solids: binder material solids of from 0.6:1 to 4:1, the whole fruit solids and binder material solids each being on a dry basis.

In this specification, the term “Binder material solids” is defined as the proportion of solid material which comes from the combination of binder materials in the mixture, which may be one or more of cereal material, starch material, dairy material, seeds, nuts, egg, or pulses.

Preferably, the mixture has a weight ratio of whole fruit solids: binder material solids of from 0.6:1 to 2.2:1. This preferred range provides enhanced balance of fruit flavour and sweetness in combination with a more crunchy texture.

It is important to ensure that the final mixture containing the above ingredients has a total moisture content of from 49 to 75 wt %, since this creates the correct rheology characteristics which in turn enable the correct type of bubble formation and matrix structure creation upon drying. Too little water makes bubbles difficult to create, which in turn prevents a light crispy texture from being formed. Too much water produces a mixture which is too low in surface tension, such that bubbles of vapour formed during drying cause severe disruption of the liquid phase and disintegration of the continuous phase, and therefore the structure of the final snack piece.

Even when the ingredient mixture has the correct range of starting moisture content, when the weight ratio of whole fruit solids: binder material solids is less than 0.6:1 there is insufficient fruit content to provide a high fruit product and the combination of a crunchy texture with a melt-in-the-mouth dissolution with low residual solids cannot readily be obtained. When the weight ratio of whole fruit solids: binder material solids is greater than 4.0:1 the resultant structure is very open and aerated and the continuous matrix is primarily composed of fruit sugar, and so the matrix is glassy, fragile and intensely sweet.

The mixture has a moisture content of from 49 to 75 wt % based on the weight of the mixture, preferably a moisture content of from 49 to 70 wt % based on the weight of the mixture.

In most cases, there is no need to add water to the ingredient mixture, because water can be provided by the fruit content, although additional water may be added to respect the required starting moisture content range, for example if dried fruit powders have been used as the primary source of whole fruit solids.

In preferred embodiments, the mixture has a whole fruit solids content, on a dry basis, of from 30 to 80 wt % based on the weight of the mixture and/or a dairy solids content, on a dry basis, of from 0 to 35 wt % based on the weight of the mixture and/or a solids content for the combination of cereal material and starch material, on a dry basis, of from 0 to 70 wt % based on the weight of the mixture.

It is preferred to eliminate any additives, such as flavorants or colorants, from the ingredients to form the snack food.

The various ingredients are selected and controlled at least partly to provide a viscosity and surface tension in the ingredient mixture that can enable the mixture to be formed, in a fourth step 8, for example by spreading or any other known forming process, into a sheet-like structure, or optionally as individual pieces.

Subsequently in a fifth step 10 the mixture is cooked in a vacuum-controlled atmosphere having a pressure of less than 1 bar absolute. Typically, the vacuum-controlled atmosphere has a pressure of less than 100 millibars absolute, most typically less than 50 millibars absolute.

In some embodiments, as illustrated in FIG. 1, the cooking step 10 comprises vacuum microwave cooking. Typically, the microwave cooking step 10 is carried out for a period of from 1 to 5 minutes. Preferably, after the microwave cooking step 10, the resultant cooked product has a moisture content of from 5 to 15 wt % based on the weight of the cooked product.

Optionally, before exposing the mixture to the vacuum-controlled atmosphere in the cooking step 10, the mixture may be pre-heated to a temperature of at least 40° C. Optionally, pre-heating may be carried out before the forming step 8.

In the embodiment of FIG. 1, the method further comprises a dehydrating step 12 after the microwave cooking step 10. The dehydrating step 12 is typically carried out in an oven at elevated temperature. Most typically, the dehydrating step 12 is carried out at a temperature of from greater than 100° C. to up to 110° C., optionally from 102° C. to 110° C. The dehydrating step 12 further reduces the moisture content of the resultant cooked product to from 0.5 to 3 wt %, optionally from 0.5 to 2 wt %, based on the weight of the dehydrated cooked product.

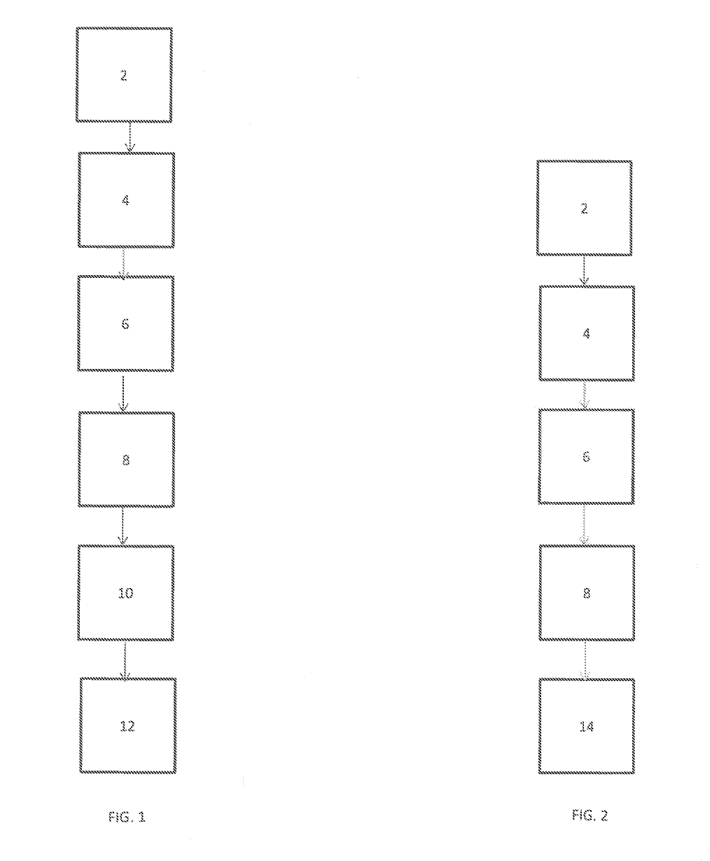

In alternative embodiments, as illustrated in FIG. 2, the cooking step 14 comprises vacuum oven cooking. The vacuum oven cooking step 14 is preceded by the same providing and mixing steps 2, 4, 6, and forming step 8. as described above with respect to the embodiment of FIG. 1, but the vacuum oven cooking step 14 comprises oven cooking at a cooking temperature of from greater than 100° C. to up to 150° C., optionally from 105° C. to 130° C., for example at about 110° C. for a period of about 20 minutes and a pressure of 50 millibars absolute. After the oven cooking step 14 the resultant cooked product has a moisture content of from 0.5 to 4 wt %, optionally from 0.5 to 2 wt %, based on the weight of the cooked product. The vacuum oven cooking step 14 enables the mixture to be cooked and dehydrated in a single process and obviates the need for a separate dehydrating step.

Optionally, after oven cooking step 14, the cooked sheet of product may be removed in a less dry state (typically from 5 to 20 wt % moisture content) and then dimensioned into individual snack pieces, and subsequently dried in a step similar to step 12 previously described, to a final moisture content of 0.5 to 4 wt %, optionally 0.5 to 2 wt %.

In either of the embodiments of FIGS. 1 and 2, during the cooking step the mixture is optionally in the form of a sheet. The sheet optionally can be dimensioned to form a single snack food piece prior to the cooking step. Optionally, a peripheral edge of the sheet is shaped by a mould or template. The sheet preferably has a thickness of from 1 to 4 mm, optionally from 1 to 3 mm, further optionally from 1 to 2 mm. The resultant snack food is in the form of a chip.

The mixture and the cooking conditions are controlled so that during the cooking step bubbles of steam form in the mixture which is initially fluid to allow bubble formation under the effect of the vacuum-controlled atmosphere. The microwave or oven power increases the temperature of the water, and the vacuum reduces the boiling point of water, so that water in the product rapidly boils off forming bubbles of steam. The steam escapes from the product, to reduce the moisture content, and the bubbles eventually form the voids in the final matrix.

If the correct starting viscosity and mixture characteristics are selected, the inventors have discovered that, surprisingly, non-spherical bubbles remain in the product, of a much larger size than are typically found in freeze-dried and similar products. Correspondingly, the products described in the invention contain thicker cell walls which create a unique texture. The non-spherical bubbles are typically orientated in line with the length of the chip, which is another distinguishing feature compared against known fruit-containing snack food products.

The resulting non-spherical voids with smooth internal surfaces are observable, visually, by micro CT and through C-Cell analysis. The C-Cell analysis is a commercially available quantitative assessment of cellular product structure, which works on a microscopic scale, and is available from Calibre Control International Limited, UK. The C-Cell analysis is a method for producing cell alignment values, cell contrast values, and number of cell values of products, using the commercially-available C-Cell apparatus.

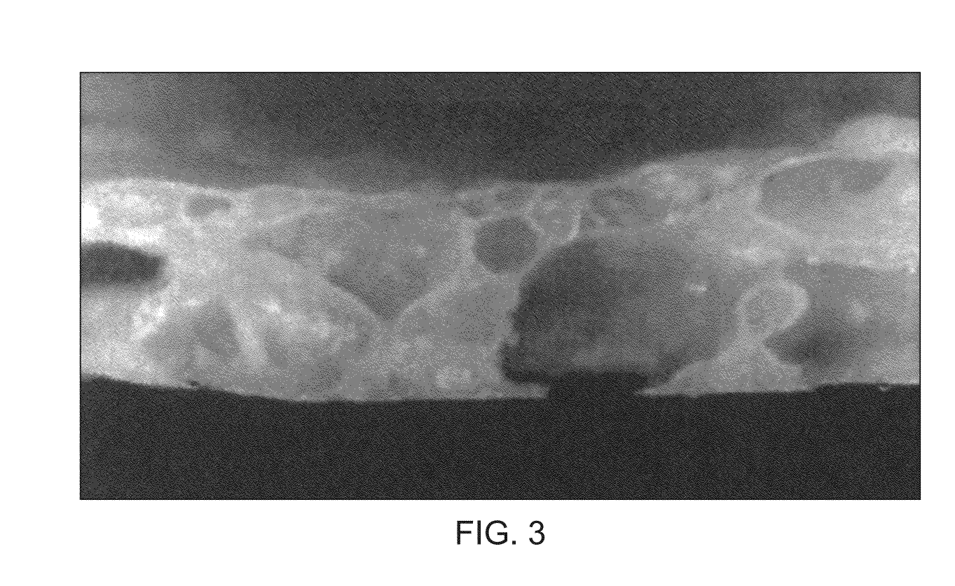

The methods of FIGS. 1 and 2 each produce a fruit-containing snack food, typically in the form of a chip, as illustrated in FIG. 3 which is a cross-section taken by light microscopy through a fruit-containing snack food chip 20 in accordance with a preferred embodiment of the present invention.

The chip 20 may have any desired regular or irregular shape, and any desired dimensions with respect to thickness, area and length/width dimensions.

The chip 20 may typically have a thickness of from 1 to 4 mm, optionally from 1 to 3 mm, further optionally from 1 to 2 mm. The chip 20 of FIG. 3 had a thickness of about 1.5 mm.

The snack food chip 20 comprises a substantially rigid matrix 22 in the form of a sheet 24. The matrix 22 defines therein a cellular structure of voids 26. As shown in FIG. 3, at least some of the voids 26 comprise elongate voids 26 extending substantially in the plane of the sheet 24.

The matrix 22 comprises a substantially homogeneous cooked mixture of the at least one fruit material and the at least one binder material, these material being described above. The matrix 22 has a weight ratio of whole fruit solids: binder material solids of from 0.6:1 to 4:1, preferably from 0.6:1 to 2.2:1, the whole fruit solids and binder material solids each being on a dry basis.

In the snack food chip 20 the fruit material may include fruit pieces distributed in a fruit containing matrix 22, and the fruit pieces may be individually visible to the human eye. Preferably, the fruit material includes cellular wall material from the fresh fruit.

In preferred embodiments, the snack food has a whole fruit solids content, on a dry basis, of from 30 to 80 wt % based on the weight of the snack food, and/or a dairy solids content, on a dry basis, of from 0 to 35 wt % based on the weight of the snack food and/or a content for the combination of cereal material and starch material, on a dry basis, of from 0 to 70 wt % based on the weight of the snack food.

Typically, the moisture content of the snack food is from 0.5 to 3 wt %, optionally from 0.5 to 2 wt %, based on the weight of the snack food.

During the vacuum cooking step, either in the vacuum microwave or in the vacuum oven, it was visually observed that a raising process occurred, and the thickness of the initial sheet increases on application of the vacuum. This indicates that large bubbles are formed in the early raising process giving the product a puffed appearance.

Without being bound by any theory, it is believed that the structure of the final matrix is primarily influenced by the viscosity and surface tension of the material whilst the product is boiling. A very low viscosity and surface tension material such as water will not form stable bubbles as there is insufficient surface tension to sustain them. During drying, the matrix increases in viscosity thereby reducing the rate of mass transfer of vapour through the matrix walls. As drying progresses, steam generated causes bubbles to form and expand, as the rate of steam generation surpasses the maximum rate of mass transfer through the film.

The viscous matrix contains increasingly large vapour pockets which periodically escape through ruptures in the bubble walls due to over-expansion. Eventually the wall sets in shape as a solid, forming characteristic elongated cells which are the result of collapsed bubbles. The mixture rigidifies as a result of the cooking process to form a cellular structure of voids within a rigid matrix, including a marked presence of elongated cells which lie predominantly longitudinally in the same plane as the chip length, as well as a range of void size. This gives the characteristic laminated and void-containing appearance of the snack food matrix. The resulting non-spherical voids with smooth internal surfaces are observable, visually, by micro CT and through C-Cell analysis as described above.

The selection of the vacuum cooking conditions, the moisture content of the ingredient mixture, and the combination of whole fruit-based solids and binder solids, both of which have a major influence on viscosity, can provide a composite fruit-based snack that has an open, light aerated texture using a vacuum oven or vacuum microwave oven.

A composite product allows a combination of fruit and other ingredients including binder to provide an appealing flavour profile, with high fruit taste.

The vacuum cooking provides expansion, via the reduced vacuum pressure, and in some embodiments a rapid dehydration, through use of a microwave or a vacuum oven, to give an open aerated light and crispy structure and to maintain fruit flavour.

In the preferred embodiments, the snack food product has an open, aerated structure that is light, crispy and then dissolves quickly in the mouth.

At greater than 80 wt % fruit content, expressed on a dry basis, and correspondingly low binder content, the snack food product is very glassy and brittle. The fragile product would not withstand transportation to the market without unacceptably high levels of breakage. Also such a product is intensely sweet, and would not be consumer acceptable for a convenient snack food.

The binder content is controlled, together with the wet ingredients, to provide the required viscosity and moisture content. The binder content does not contribute to the desired fruit flavour.

When the fruit content is below 30 wt %, the fruit flavour is low and other flavours from the other ingredients predominate, and additionally significant quantities of other ingredients also result in a harder and crunchier texture with reduced melt-in-the-mouth dissolution characteristics. This effect is particularly dominant when the binder contains cereal material.

When the binder material comprises primarily dry ingredients, the resultant texture is lighter, crunchier, and less tooth-clogging. Increased binder tends to provide an increase in residual solids and reduced melt-in-the-mouth dissolution characteristics. This effect is particularly dominant when the binder contains cereal material.

When the composition comprises from 30 to 80 wt % fruit content, the moisture content of the mixture is ideally from 49 to 75 wt % moisture. At greater than 75 wt % moisture content the mixture is wetter, resulting in a less dense, more open structure creating a fragile texture, whereas less than 49 wt % moisture content gives a drier, more powdery texture with a longer breakdown period in the mouth, and less melt-in-the-mouth.

The present invention will now be described in greater detail with reference to the following non-limiting Examples.

### EXAMPLE 1

A snack food in the form of an apple and oat chip was produced in accordance with the present invention.

A concentrated apple puree, oat flour and starch were provided. The concentrated apple puree was commercially available and contained 27.5 wt % solids. The oat flour was commercially available finely ground oat flour containing approximately 92 wt % solids. The starch was commercially available pre-gelatinised corn starch containing 95.5 wt % solids These ingredients were mixed together in the following weight ratios 88 wt % concentrated apple puree, 10 wt % oat flour and 2 wt % starch. The initial moisture content was from 60 to 70 wt % water based on the total weight of the mixture.

The raw ingredients were taken from storage, dispensed into a container, and hand mixed using a kitchen spoon and bowl to form a visually homogenous mixture. The mixing period was from 15 to 20 minutes at a temperature of 20° C.±5° C. and at atmospheric pressure (i.e. 1000 mb±70 mb absolute).

The resultant mix was in the form of a spreadable paste.

The mix was manually spread onto a sheet of greaseproof paper. A stencil was provided over the greaseproof paper and the stencil included a series of circular holes of diameter 55 mm. The stencil had a thickness of 1.5 mm. The batter was spread using a straight flat edge to fill the holes. Thereafter the stencil was removed from the sheet of greaseproof paper to leave a series of discs, each 55 mm in diameter and 1.5 mm in thickness, on the sheet. Each disc had a weight of from 2 to 4 grams and the total weight of the discs was approximately 36 to 72 grams.

The paper carrying the discs was placed into a catering microwave oven having a maximum microwave power output of 1500 W. The microwave oven had first been adapted using readily available engineering techniques such that the chamber could operate under a vacuum. Someone skilled in the art can easily adapt an appliance by connecting the unit to a vacuum pump and ensuring that all relevant seals around the container are substantially air tight.

A vacuum was applied to reduce the pressure within the oven to less than 50 millibars absolute. The microwave oven was switched on for a period of 1 minute to 2 minutes at 1500 W full power, thereafter for a period of from 30 to 50 seconds at half power, which cycled alternatively between full power and off for equal time periods.

The vacuum microwave cooking step reduced the initial moisture content of from 60 to 75 wt % water based on the total weight of the mixture down to a value of from 10 to 15 wt % water based on the total weight of the cooked mixture.

Thereafter the cooked sheets were subjected to a dehydrating step in an oven at a temperature of 103° C. and at atmospheric pressure (i.e. 1000 mb±70 mb absolute) for a period of 15 to 20 minutes. The dehydrating step further reduced the moisture content of the final dehydrated and cooked chip to a value of about 1 wt % water based on the total weight of the final dehydrated and cooked chip.

The chip contained 68.0 wt % whole fruit solids and 31.0 wt % binder material solids and the weight ratio of whole fruit solids: binder material solids was 2.2:1.

The final dehydrated and cooked chip was crunchy and had a melt-in-the-mouth mouth feel which dissolved in the mouth leaving substantially no residual solid material in the mouth. The chip had a highly fruity taste, and was not over sweet. The physical characteristics of the chip were robust enough to withstand a qualitative breakage challenge test.

### EXAMPLE 2

A snack food in the form of apple, strawberry and yogurt chip was produced in accordance with the present invention. The snack food had the following ingredients, the wt % amounts being based on the weight of the initial mixture. The fruit material comprised concentrated apple puree 42 wt % and strawberry puree 35 wt %. The apple puree was commercially available and contained approximately 27.5 wt % solids. The strawberry puree was also commercially available and contained approximately 8.5 wt % solids. The binder comprised cereal material and dairy material. The cereal material comprised oat flour 13wt %. The oat flour was as specified in Example 1. The dairy material was yoghurt powder at 10 wt %. The yogurt powder was Beatreme 8413 low fat yogurt powder from Kerry Ingredients Ltd and contained approximately 96 wt % solids.

The initial moisture content was from 60 to 70 wt % water based on the total weight of the mixture. The chip contained 40 wt % whole fruit solids and 59 wt % binder material solids and the weight ratio of whole fruit solids: binder material solids was 0.7:1.

The raw ingredients were taken from storage, dispensed into a container, and hand mixed using a kitchen spoon and bowl to form a visually homogenous mixture. The mixing period was from 15 to 20 minutes at a temperature of 20° C.±5° C. and at atmospheric pressure (i.e. 1000 mb±70 mb absolute).

The resultant mix was in the form of a spreadable paste.

The mix was manually spread onto a sheet of greaseproof paper. A stencil was provided over the greaseproof paper and the stencil included a series of circular holes of diameter 55 mm. The stencil had a thickness of 1.0 mm. The batter was spread using a straight flat edge to fill the holes. Thereafter the stencil was removed from the sheet of greaseproof paper to leave a series of discs, each 55 mm in diameter and 1.0 mm in thickness, on the sheet. Each disc had a weight of from 1 to 2 grams and the total weight of the discs was 18 to 36 grams.

Then the sheets were subjected to vacuum microwave cooking and dehydration as described above for Example 1.

The final dehydrated and cooked chip had a moisture content of about 1 wt % based on the total weight of the chip.

The final dehydrated and cooked chip was crunchy and had a melt-in-the-mouth mouth feel which dissolved in the mouth leaving substantially no residual solid material in the mouth. The chip had a fruity taste, and was not over sweet. The chip had a microstructure similar to that shown in FIG. 3.

### EXAMPLE 3

A snack food in the form of apple and starch chip was produced in accordance with the present invention. The snack food had the following ingredients, the wt % amounts being based on the weight of the initial mixture. The fruit material comprised concentrated apple puree 93 wt % (as described in Example 1). The binder comprised starch material at 7% wt %.

The initial moisture content was from 60 to 70 wt % water based on the total weight of the mixture. The chip contained 79 wt % whole fruit solids and 20 wt % binder material solids and the weight ratio of whole fruit solids: binder material solids was 4.0:1.

The raw ingredients were taken from storage, dispensed into a container, and hand mixed using a kitchen spoon and bowl to form a visually homogenous mixture. The mixing period was from 15 to 20 minutes at a temperature of 20° C.±5° C. and at atmospheric pressure (i.e. 1000 mb±70 mb absolute).

The resultant mix was in the form of a spreadable paste.

The mix was manually spread onto a sheet of greaseproof paper. A stencil was provided over the greaseproof paper and the stencil included a series of circular holes of diameter 55 mm. The stencil had a thickness of 4.0 mm. The batter was spread using a straight flat edge to fill the holes. Thereafter the stencil was removed from the sheet of greaseproof paper to leave a series of discs, each 55 mm in diameter and 4.0 mm in thickness, on the sheet. Each disc had a weight of from 1 to 2 grams and the total weight of the discs was 18-36 grams.

Then the sheets were subjected to vacuum microwave cooking. The microwave oven was switched on for a period of 1 minute to 2 minutes at 1500 W full power, thereafter for a period of from 1.5 to 2.5 minutes at half power. Then the sheets were subjected to dehydration as described above for Example 1.

The final dehydrated and cooked chip had a moisture content of about 1 wt % based on the total weight of the chip.

The final dehydrated and cooked chip was crunchy and had a melt-in-the-mouth mouth feel which dissolved in the mouth leaving substantially no residual solid material in the mouth. The chip had a fruity taste, and was not over sweet.

### EXAMPLE 4

A snack food in the form of an apple, oat and starch chip was produced in accordance with the present invention.

A concentrated apple puree, oat flour and starch were provided. The ingredients are as described in example 1. These ingredients were mixed together in the following weight ratios 65 wt % concentrated apple puree, 30 wt % oat flour and 5 wt % starch. The initial moisture content was from 49 to 55 wt % water based on the total weight of the mixture.

The raw ingredients were taken from storage, dispensed into a container, and hand mixed as described in Example 1.

The resultant mix was in the form of a spreadable paste.

The mix was sheeted as in Example 1. Each disc had a weight of from 2 to 4 grams and the total weight of the discs was approximately 36 to 72 grams.

Then the sheets were then placed into a vacuum oven on pre-heated platens. The platens were connected to a heat source and directly conducted heat through the greaseproof paper sheet to the discs of product mixture. A vacuum was applied to reduce the pressure within the oven to less than 50 millibars absolute. The sheets were then cooked at 110° C. for 30 minutes.

The final dehydrated and cooked chip had a moisture content of about 1 wt % based on the total weight of the chip.

The chip contained 35.0 wt % fruit solids and 64 wt % binder material solids and the weight ratio of whole fruit solids: binder material solids was 0.6:1.

The final dehydrated and cooked chip was crunchy and had a melt-in-the-mouth mouth feel which dissolved in the mouth leaving substantially no residual solid material in the mouth. The chip had a highly fruity taste, and was not over sweet.

Measuring the Product Characteristics of Examples 1 to 4

As described above, various snack foods were produced in accordance with the method of Examples 1 to 4. The whole fruit solids to binder solids ratio is listed in Table 1 for each of the Examples 1 to 4. The texture is shown in the last column. For each of the Examples 1 to 4, it may be seen that the desired texture was achieved and in each case the weight ratio of whole fruit solids to binder solids was within the range of from 0.6:1 to less than 4.0:1.

TABLE 1

| | Moisture | Fruit | Binder | Ratio of | |
|---|---|---|---|---|---|
| | content | solids | solids | fruit | |
| | mix | wt % | wt % | solids to | Tex- |
| Example | (wt %) | dry basis | dry basis | binder solids | ture |
| Example 1 | 64 | 68 | 31 | 2.2:1 | * |
| Example 2 | 63.2 | 40 | 59 | 0.7:1 | * |
| Example 3 | 67.3 | 79 | 20 | 4.0:1 | * |
| Example 4 | 50 | 35 | 64 | 0.6:1 | * |
| Comp. Ex. 5 | 41 | 6 | 93 | 0.1:1 | > |
| (42% fruit | | | | | |
| puree, 6% oat | | | | | |
| flour, 40% | | | | | |
| starch, 12% | | | | | |
| sugar) | | | | | |
| Comp. Ex. 6 | 73 | 82 | 17 | 4.9:1 | @ |
| (95% fruit | | | | | |
| puree, 5% | | | | | |
| starch) | | | | | |
| Comp. Ex. 7 | 82 | 75 | 24 | 3.0:1 | # |
| (95% fruit | | | | | |
| puree not | | | | | |
| concentrated, | | | | | |
| 5% starch) | | | | | |

> = crunchy texture, poor aeration, poor dissolution, minimal fruit flavour
* = crunchy aerated texture, good mouthfeel, dissolution with low residual content
@ = glassy fragile structure, too sweet
# = too wet to be dried to form a solid sheet or chip

The aerated texture of the snack chips produced in accordance with Examples 1 to 4 was determined by C-Cell analysis, as described hereinbelow.

C-Cell Analysis

The aerated texture of the snack chips produced in accordance with Examples 1 to 4 was determined by C-Cell analysis, a proprietary image analysis software system for quantifying cell characteristics and external features, particularly of food products, which is available in commerce from Calibre Control International Limited, United Kingdom.

A cross-section of the snack chip was prepared by snapping or breaking the chip in order to expose the internal structure. The exposed edge was then filed down with sandpaper or cut with a sharp knife and any debris removed by a jet of compressed air. The resultant surface was flat. The chip was then mounted, using a pressure-sensitive adhesive putty, to expose the cut surface. C-Cell analysis was then performed and the image analysed and data collected. This showed the cell alignment, cell contrast and number of cells within the aerated structure. This is represented as a processed image, which shows cell size and depth.

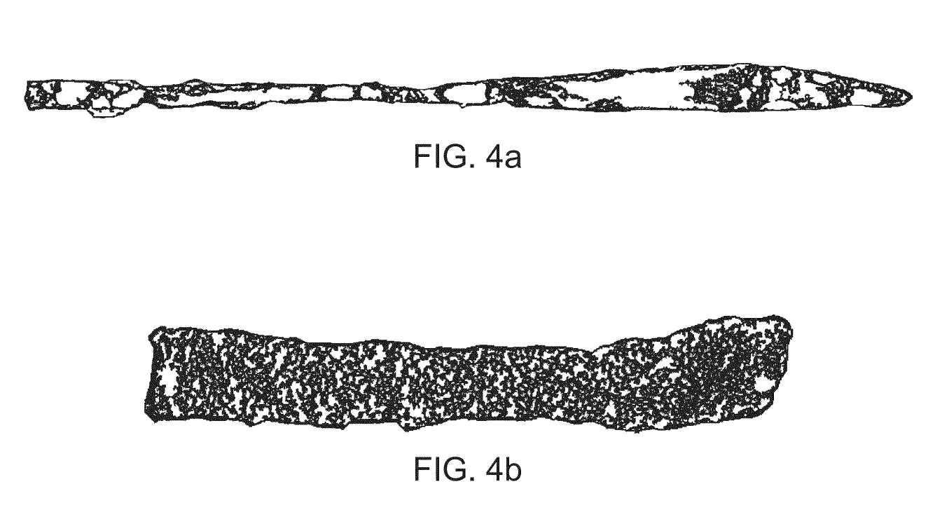

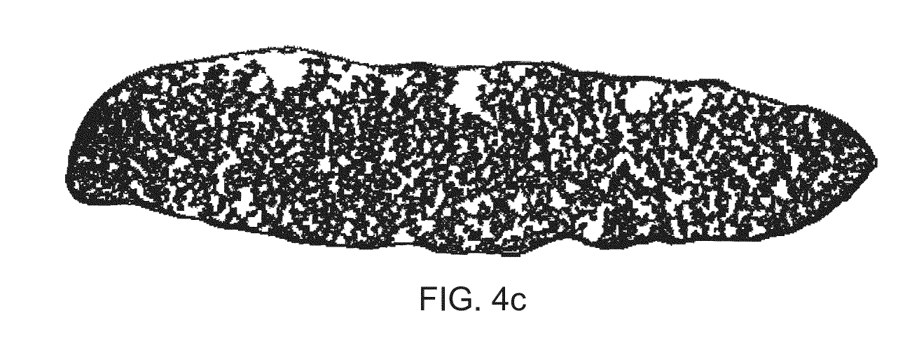

Each void or ‘cell’ is colour coded according to its prominence, based on its area and depth, quantified by the ‘volume’ parameter. Small cells are coloured in dark blue and larger ones are shown in lighter shades of blue, green and yellow. Cells large enough to be classified as holes are outlined in red. In FIGS. 4a to 4c the different colours are shown in greyscale.

Cell alignment value represents the extent to which cells are aligned in a parallel direction. Values range from 0 to 1. High values represent parallel alignment of cells in a single direction, as exemplified by some types of laminated product. Lower values indicate greater variation in cell orientation.

Cell contrast is given as the ratio of the mean brightness of cells to the mean brightness of cell walls. Higher values indicate shallower cells with little contrast, which will often give a product a lighter appearance.

The number of discrete cells detected within the slice. Higher values may be due to a finer structure or a larger total slice area. The cells are shown in the cell image. When interpreting this image, cells only touching diagonally are considered to be discrete.

It is possible to take a number of C-Cell analyses taken from replicate tests using a range of test products, and perform a statistical analysis of variance in order to ascertain confidence limits of statistically significant difference. In this way the inventors have demonstrated that the methods described herein and the food products made using these methods are unique and easily distinguishable from any similar fruit containing products in the prior art.

FIG. 4a shows a cross-sectional C-Cell image (in greyscale) of a snack chip of Example 2 produced in accordance with the present invention. As also shown in FIG. 3, the cellular voids are aligned along the plane of the chip.

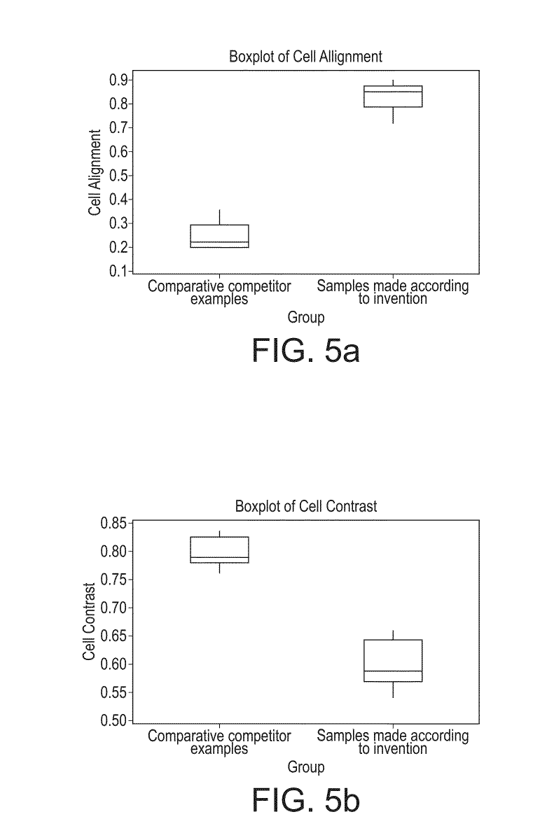

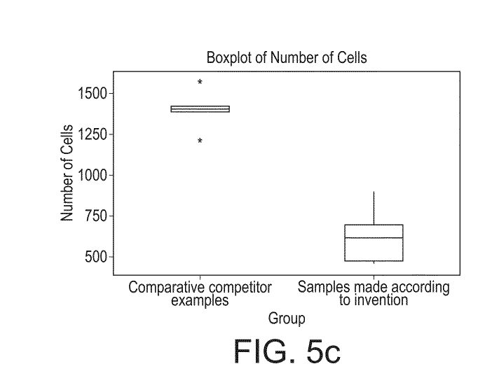

The aerated texture of the snack chips produced in accordance with Examples 1 to 4 was determined by C-Cell analysis, and the data was analysed to determine cell contrast, the number of cells and cell alignment, as summarised in Table 2. The same data is illustrated as box plots in FIGS. 5a, 5b and 5c.

TABLE 2

| | Cell | Number of | Cell |
|---|---|---|---|
| | Contrast | Cells | Alignment |
| Example 1 | 0.57-0.66 | 850-962 | 0.68-0.75 |
| Example 2 | 0.5-0.6 | 462-634 | 0.85-0.92 |
| Example 3 | 0.56-0.64 | 580-634 | 0.65-0.73 |
| Example 4 | 0.61-0.68 | 602-654 | 0.71-0.80 |
| Comparative Example 8 - | 0.78 | 1385 | 0.35 |
| Commercial “Crunchy Apple” | | | |
| Comparative Example 9 - | 0.76 | 1400 | 0.29 |
| Commercial “Crunchy Pineapple” | | | |
| Comparative Example 10 - | 0.83 | 1208 | 0.22 |
| Commercial “Banana, Mango and | | | |
| Passion fruit Smoothie Melts” | | | |
| Comparative Example 11- | 0.79 | 1419 | 0.20 |
| Commercial “Strawberry and Banana | | | |
| Smoothie Melts” | | | |
| Comparative Example 12 - | 0.83 | 1407 | 0.19 |
| Commercial “Apple Fruit Crisps” | | | |
| Comparative Example 13 - | 0.82 | 1567 | 0.20 |
| Commercial “Banana Fruit Crisps” | | | |
| Comparative Example 14 - | 0.78 | 1399 | 0.29 |
| Commercial “Apple Crisps” | | | |

For the snack food according to the present invention, typically the cells are aligned in a single parallel direction, giving a cell alignment value of greater than 0.6 as determined by C-Cell analysis; and/or typically the cells have cell contrast value of less than 0.7 as determined by C-Cell analysis; and/or typically the number of cells as determined by C-Cell analysis is less than 1000.

It may be seen that for each of Examples 1, 2, 3 and 4 the snack food product had an aerated structure with a broad cell size distribution. As also shown in FIG. 3, at least some of the voids comprised elongate voids extending substantially in the plane of the sheet.

### COMPARATIVE EXAMPLES 5 TO 7

Various snack foods were produced substantially in accordance with the method of Example 1 excepting the whole fruit solids to binder ratio or moisture level as specified in Table 1. The composition of the ingredient mix is listed in Table 1 for each of the Comparative Examples 5 to 7. The texture is shown in the last column. For each of the Comparative Examples 5 to 7, it may be seen that the desired texture was not achieved, and in each case there was no combination of the weight ratio of whole fruit solids to binder solids being within the range of from 0.6:1 to less than 4.0:1 and a moisture content of the ingredient mixture being from 49 to 75 wt %.

### COMPARATIVE EXAMPLES 8 TO 14

Various commercially available fruit-containing snack foods were tested by C-Cell analysis, substantially in accordance with the testing carried out on Examples 1 to 4. The results are shown in Table 2. The data determined by C-Cell analysis was analysed to determine cell contrast, the number of cells and cell alignment, as summarised in Table 2, and again the same data is illustrated as box plots in FIGS. 5a, 5b and 5c.

A comparison of all the data of Table 2 and FIGS. 5a, 5b and 5c shows that the method of the invention produces a high degree of cell alignment, a low degree of cell contrast and a low number of cells as compared to the commercially available fruit-containing snack foods. Also, the cell contrast, the number of cells and cell alignment was relatively consistent for the products of Examples 1 to 4, which illustrates that the method of the invention produces a range of product with a substantially consistent texture.

FIGS. 4b and 4c show a cross-sectional C-Cell image of a snack chip not produced in accordance with the present invention. FIG. 4b is a freeze-dried apple slice of Comparative Example 12 and FIG. 4c is a fruit-only freeze dried banana, mango and passion fruit composite of Comparative Example 10. In contrast to the microstructure shown in FIG. 3 and FIG. 4a, any cellular voids are substantially not aligned along the plane of the chip.

Various modifications to the embodiments of the present invention described herein will be readily apparent to those skilled in the art and such modifications are included within the scope to the invention as defined in the appended claims.

1. A method of manufacturing a fruit-containing snack food, the method comprising the steps of:
a. providing at least one fruit material comprising whole fruit solids;
b. providing at least one binder material, the at least one binder material being selected from the group comprising cereal material, starch material, nuts seeds, egg, soy, pulses and dairy material;
c. mixing together the at least one fruit material and the at least one binder material to form a mixture having a weight ratio of whole fruit solids: binder material solids of from 0.6:1 to less than 4:1, the fruit solids and binder material solids each being on a dry basis, and a moisture content of from 49 to 75 wt % based on the weight of the mixture;
d. forming the mixture such that it has a thickness of from 1 to 4 mm;
e. microwave cooking the mixture in a vacuum-controlled atmosphere having a pressure of less than 1 bar absolute wherein after the microwave cooking step e the resultant cooked product has a moisture content of from 5 to 15 wt % based on the weight of the cooked product; and
f. dehydrating the resultant cooked product to reduce the moisture content of the resultant cooked product to from 0.5 to 3 wt % based on the weight of the dehydrated cooked product;
wherein the cooking conditions are controlled so that during the cooking step e, the following sub-steps occur:
i. bubbles of steam form in the mixture which is initially fluid to allow bubble formation under the effect of the vacuum-controlled atmosphere;
ii. at least some of the bubbles coalesce to form elongate bubbles extending substantially in the plane of the sheet; and
iii. the mixture rigidifies as a result of the cooking process to form a cellular structure of voids within a rigid matrix.

2. A method according to claim 1 wherein the at least one fruit material is in the form of one or more of a fruit puree, fruit juice, fruit pieces, each in a fresh or concentrated form, or fruit powder produced by a spray drying or freeze drying process.

3. A method according to claim 1 wherein the whole fruit solids are in the form of one or more of a fruit puree, or fruit powder or flake produced by spray drying or freeze drying or flaking whole fruit material which still contains cellular wall material from the fresh fruit.

4. A method according to claim 1 wherein the at least one fruit material is selected from strawberry, raspberry, blackberry, blackcurrant, blueberry, cranberry, banana, apple, pear, plum, peach, apricot, orange, mandarin, nectarine, lemon, grapefruit, lime, mango, cherry, pineapple, kiwi, pomegranate and grape or any mixture of two or more of these fruits.

5. A method according to claim 1 wherein the cereal material is in the form of at least one of a cereal flour, a cereal powder, cereal flakes, or cereal granules or any mixture of two or more of these cereal materials.

6. A method according to claim 5 wherein the cereal flour, powder, flakes and/or granules are selected from one or more of oats, wheat, rice, corn and barley or any mixture thereof.

7. A method according to claim 1 wherein the starch material is selected from one or more of oat starch, wheat starch, rice starch, corn starch, tapioca starch and potato starch or any mixture thereof, any such starch material optionally being a modified starch or a pre-gelatinised starch.

8. A method according to claim 1 wherein the dairy material is in the form of at least one of fresh yoghurt, kefir, milk, cream, whey, a one or more milk derivatives or dry powder or any mixture thereof.

9. A method according to claim 1 wherein the binder material additionally comprises at least one sugar material.

10. A method according to claim 9 wherein the at least one sugar material is selected from sucrose, fructose, honey and refined sugar syrup or any mixture thereof, including fructose derived from fruit juice concentrate.

11. A method according to claim 1 wherein the mixture has a weight ratio of whole fruit solids: binder material solids of from 0.6:1 to 2.2:1.

12. A method according to claim 1 wherein the mixture has a moisture content of from 49 to 70 wt % based on the weight of the mixture.

13. A method according to claim 1 wherein the mixture has a whole fruit solids content, on a dry basis, of from 30 to 80 wt % based on the weight of the mixture.

14. A method according to claim 1 wherein the mixture has a dairy solids content, on a dry basis, of from 0 to 35 wt % based on the weight of the mixture.

15. A method according to claim 1 wherein the mixture has a solids content for the combination of cereal material and starch material, on a dry basis, of from 0 to 70 wt % based on the weight of the mixture.

16. A method according to claim 1 wherein the mixture has a combined solids content for the nuts or seeds or soy or pulses or egg, on a dry basis, of from 0 to 65 wt % based on the weight of the mixture.

17. A method according to claim 1 wherein the mixture comprises from 15 to 93 wt % of the at least one fruit material, from 0 to 35 wt % of the at least one cereal material, from 0 to 20 wt % of the at least one starch material and from 0 to 35 wt % of the at least one dairy material, each based on the weight of the mixture.

18. A method according to claim 1 wherein the mixture consists of the at least one fruit material and the at least one binder material selected from the group consisting of cereal material, starch material and dairy material, optionally wherein the binder material additionally comprises at least one sugar material, and the mixture optionally comprising additional water.

19-20. (canceled)

21. A method according to claim 1 wherein the microwave cooking step e is carried out for a period of from 1 to 5 minutes.

22. A method according to claim 1wherein the dehydrating step reducing the moisture content of the resultant cooked product to from 0.5 to 2 wt %, based on the weight of the dehydrated cooked product.

23. A method according to claim 22 wherein dehydrating step f is carried out at a temperature of from greater than 100° C. to up to 110° C.

24-26. (canceled)

27. A method according to claim 1 wherein the sheet is dimensioned to form a single snack food piece.

28. A method according to claim 27 wherein the single snack food piece is dimensioned part-way through cooking step e.

29. A method according to claim 27 wherein a peripheral edge of the sheet is shaped by a mould or template.

30. A method according to claim 1 further comprising the step, before exposing the mixture to the vacuum-controlled atmosphere in the cooking step e, of pre-heating the mixture to a temperature of at least 40° C.

31. A fruit-containing snack food, the snack food comprising a substantially rigid matrix in the form of a sheet having a thickness of from 1 to 4 mm and defining therein a cellular structure of cellular voids, wherein at least some of the voids comprise elongate cellular voids extending substantially in the plane of the sheet, the cellular voids are aligned in a single parallel direction giving a cell alignment value of greater than 0.6 as determined by C-Cell analysis, the cellular voids have cell contrast value of less than 0.7 as determined by C-Cell analysis, and the number of cellular voids as determined by C-Cell analysis is less than 1000, and defining therein a cellular structure of voids, the matrix comprising a substantially homogeneous cooked mixture of at least one fruit material comprising whole fruit solids and at least one binder material, the at least one binder material being selected from the group comprising cereal material, starch material and dairy material, nuts, seeds, egg, pulses, soy and dairy material; wherein the matrix has a weight ratio of whole fruit solids: binder material solids of from 0.6:1 to less than 4:1, the whole fruit solids and binder material solids each being on a dry basis, wherein the moisture content of the snack food is from 0.5 to 3 weight percent based on the weight of the snack food.

32. A snack food according to claim 31 wherein the at least one fruit material includes fruit pieces distributed in a fruit containing matrix.

33. A snack food according to claim 31 wherein the at least one fruit material includes cellular wall material from the fresh fruit.

34. A snack food according to claim 31 wherein the at least one fruit material is selected from strawberry, raspberry, blackberry, blackcurrant, blueberry, cranberry, banana, apple, pear, plum, peach, apricot, orange, mandarin, lemon, grapefruit, lime, mango, cherry, pineapple, kiwi, pomegranate and grape or any mixture of two or more of these fruits.

35. A snack food according to claim 31 wherein the cereal material is selected from one or more of oats, wheat, rice, corn and barley or any mixture thereof.

36. A snack food according to claim 31 wherein the starch material is selected from one or more of oat starch, wheat starch, rice starch, corn starch, tapioca starch and potato starch or any mixture thereof, any such starch material optionally being a modified starch or a pre-gelatinised starch.

37. A snack food according to claim 31 wherein the binder material includes pulses, seeds, egg, or nuts.

38. A snack food according to claim 31 wherein the dairy material is in the form of yoghurt.

39. A snack food according to claim 31 wherein the binder material additionally comprises at least one sugar material.

40. A snack food according to claim 39 wherein the at least one sugar material is selected from sucrose, fructose, honey and refined sugar syrup or any mixture thereof.

41. A snack food according to claim 31 wherein the snack food has a weight ratio of whole fruit solids: binder material solids of from 0.6:1 to 2.2:1.

42. A snack food according to claim 31 wherein the snack food has a whole fruit solids content, on a dry basis, of from 30 to 80 wt % based on the weight of the snack food.

43. A snack food according to any claim 31 wherein the snack food has a dairy solids content, on a dry basis, of from 0 to 35 wt % based on the weight of the snack food.

44. A snack food according to claim 31 wherein the snack food has a solids content for the combination of cereal material and starch material, on a dry basis, of from 0 to 70 wt % based on the weight of the snack food.

45. A snack food according to claim 31 wherein the snack food has a total binder solids content, on a dry basis, of from 0 to 70 wt % based on the weight of the snack food.

46. A snack food according to claim 31 wherein the moisture content of the snack food is from 0.5 to 2 wt %, based on the weight of the snack food.

47-50. (canceled)

51. A snack food according to claim 31 wherein the sheet has a thickness of from 1 to 4 mm.
